(19) United States
(12) Patent Application Publication
(10) Pub. No.: US 2006/0224628 A1
(43) Pub. Date: Oct. 5, 2006

(54) Modeling for data services

(75) Inventor: Naveen Gupta, Sunnyvale, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/341,235

(22) Filed: Jan. 27, 2006

Related U.S. Application Data
(60) Provisional application No. 60/666,079, filed on Mar. 29, 2005.

(51) Int. Cl. G06F 17/00

(52) U.S. Cl. 707/104.1

(57) ABSTRACT

In accordance with embodiments of the present invention, there are provided mechanisms and methods for modeling data services. These mechanisms and methods for modeling data services make it possible for organizations to lessen dependence on service implementations. In an example embodiment, modeling provides a unified view of disparate services to one or more requestors. Requestors may be users, proxies or automated entities. The view of data services provided to the requestor may be substantially independent of structure or format of the data services underlying the model. The data services underlying the model are mapped to the view. This ability of a liquid data framework to support modeling data services makes it possible to attain improved usage from computing resources in a computer system. In other example embodiments, multiple models of data services may be created, stored and used to increase flexibility in changing or adapting the organization's IT infrastructure.

### CLAIM OF PRIORITY

The present application claims the benefit of:

U.S. Patent Application No. 60/666,079, entitled MODELING FOR DATA SERVICES, by Naveen Gupta, filed Mar. 29, 2005 (Attorney Docket No. BEAS-01753us01).

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. Provisional Patent Application No. 60/665,908 entitled “LIQUID DATA SERVICES”, filed on Mar. 28, 2005, Attorney Docket No. BEAS 1753US0;

U.S. Provisional Patent Application No. 60/666,079 entitled “MODELING FOR DATA SERVICES”, filed on Mar. 29, 2005, Attorney Docket No. BEAS 1753US1;

U.S. Provisional Patent Application No. 60/665,768 entitled “USING QUERY PLANS FOR BUILDING AND PERFORMANCE TUNING SERVICES”, filed on Mar. 28, 2005, Attorney Docket No. BEAS 1753US2;

U.S. Provisional Patent Application No. 60/665,696 entitled “SECURITY DATA REDACTION”, filed on Mar. 28, 2005, Attorney Docket No. BEAS 1753US3;

U.S. Provisional Patent Application No. 60/665,667 entitled “DATA REDACTION POLICIES”, filed on Mar. 28, 2005, Attorney Docket No. BEAS 1753US4;

U.S. Provisional Patent Application No. 60/665,944 entitled “SMART SERVICES”, filed on Mar. 29, 2005, Attorney Docket No. BEAS 1753US5;

U.S. Provisional Patent Application No. 60/665,943 entitled “AD HOC QUERIES FOR SERVICES”, filed on Mar. 29, 2005, Attorney Docket No. BEAS 1753US6; and

U.S. Provisional Patent Application No. 60/665,964 entitled “SQL INTERFACE FOR SERVICES”, filed on Mar. 29, 2005, Attorney Docket No. BEAS 1753US7.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to accessing services on behalf of applications, and more particularly to a mechanism for modeling data services.

### BACKGROUND

Increasingly, enterprises are looking for ways to simplify access and organization of Information Technology (IT) services. One mechanism for providing such IT simplification is Service Oriented Architecture (SOA). Application of SOA principles promises faster development cycles, increased reusability and better change tolerance for software components. Unfortunately, enterprises that implement SOA often find that the start-up complexities of SOA delays, if not derails, the expected return on investment. While SOA simplifies the complexity of an IT environment, organizations lack sufficient experience with SOA technology required for a quick, trouble-free implementation. Compounding this experience gap, graphical tools for implementing SOA are not readily available, so that data services for use in SOA environments often must be hand-coded. For enterprise-class portal and Web applications, for example, a majority of application development time can be spent on managing data access. A number of factors make data programming difficult and time-consuming, including a lack of flexibility in conventional data services.

Today most enterprises develop data services by custom coding in their favorite Integrated Development Environment (IDE). Some companies also use a business process management (BPM) type tool to help them with transformations commonly needed in creating data services. But these approaches essentially rely on hand coding and fail to meet the complexities of creating and managing an enterprise class data services layer. Users, however, desire flexibility in the organization of data services of the enterprises' IT installation. Unfortunately, conventional approaches require the designer of the IT installation to anticipate all of the possible services and provide users access to the services for each possible variation hand coded. Such conventional approaches are unable to support growth or change in the services of the IT installation.

### BRIEF DESCRIPTION OF THE DRAWINGS

FIGS. 1A-1B are functional block diagrams illustrating an example computing environment in which techniques for modeling data services may be implemented in one embodiment.

FIG. 2A is an operational flow diagram illustrating a high level overview of a technique for modeling data services of one embodiment of the present invention.

FIG. 2B is an operational flow diagram illustrating a high level overview of a client process operable with the technique for modeling a service illustrated in FIG. 2A.

FIG. 2C is an operational flow diagram of an example a technique for servicing a request to access a service, which may be used in conjunction with the technique illustrated in FIG. 2A.

FIG. 3A-3B are screen shots illustrating a high level overview of an example view and model creation tool operable in one embodiment of the present invention.

FIG. 4 is a hardware block diagram of an example computer system, which may be used to embody one or more components of an embodiment of the present invention.

### DETAILED DESCRIPTION

In accordance with embodiments of the present invention, there are provided mechanisms and methods for modeling data services. These mechanisms and methods for modeling data services make it possible for organizations to lessen dependence on service implementations by providing a unified view of disparate services to one or more requesters. Requestors may be users, proxies or automated entities. The view of data services provided to the requestor may be substantially independent of structure or format of the data services underlying the model. The data services underlying the model are mapped to the view. This ability of a liquid data framework to support modeling data services makes it possible to attain improved usage from computing resources in a computer system. In other example embodiments, multiple models of data services may be created, stored and used to increase flexibility in changing or adapting the organization's IT infrastructure.

In one embodiment, there is provided a method for modeling data services. One embodiment of the method includes determining information of interest to at least one requestor. A data model for data services is created based upon the determination of which data services are relevant to the information of interest. A view of the data services available to the requestor is presented. The view of data services is substantially independent of structure or format of the data services underlying the model. Data services underlying the model are mapped to the view.

In one embodiment, model based request processing is provided. One embodiment of the method includes receiving a request to access at least one service in the view. A request to access at least one of a plurality of services underlying the data services model based upon the request is prepared by mapping at least one service in the request to at least one underlying service. The at least one underlying service is accessed to obtain a result set. A result set for the requestor is prepared. The result set for the requestor includes data selected from the result set(s) received from the at least one underlying service by mapping the data selected from the result set(s) received from the at least one underlying service to the view associated with the requestor.

As used herein, the term service is intended to be broadly construed to include any application, program or process resident on one or more computing devices capable of providing services to a requestor or other recipient, including without limitation network based applications, web based server resident applications, web portals, search engines, photographic, audio or video information storage applications, e-Commerce applications, backup or other storage applications, sales/revenue planning, marketing, forecasting, accounting, inventory management applications and other business applications and other contemplated computer implemented services. The term result set is intended to be broadly construed to include any result provided by one or more services. Result sets may include multiple entries into a single document, file, communication or other data construct. As used herein, the term view is intended to be broadly construed to include any mechanism that provides a presentation of data and/or services in a format suited for a particular application, service, client or process. The presentation may be virtualized, filtered, molded, or shaped. For example, data returned by services to a particular application (or other service acting as a requester or client) can be mapped to a view associated with that application (or service). Embodiments can provide multiple views of available services to enable organizations to compartmentalize or streamline access to services, increasing the security of the organization's IT infrastructure. As used herein, the term model is intended to be broadly construed to include any construct for representing a plurality of entities in information and at least one relationship between the entities.

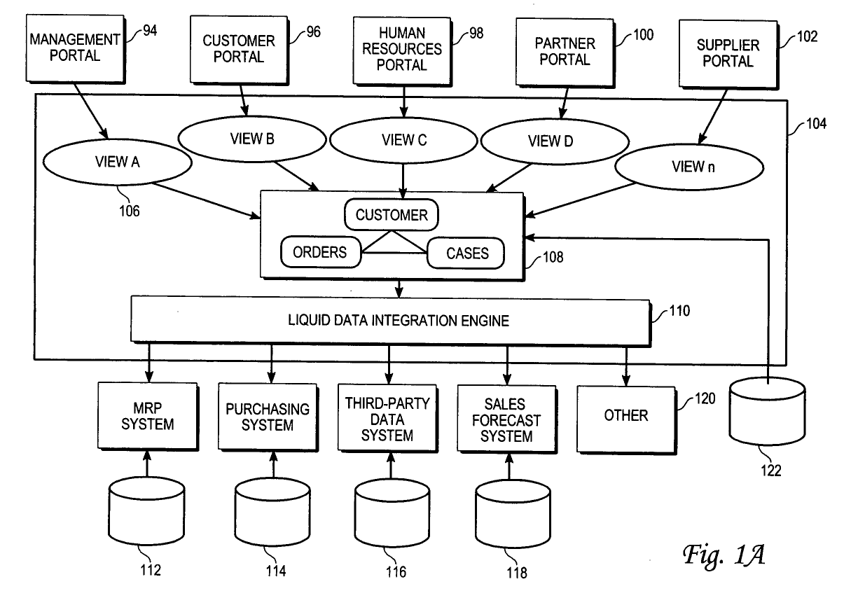

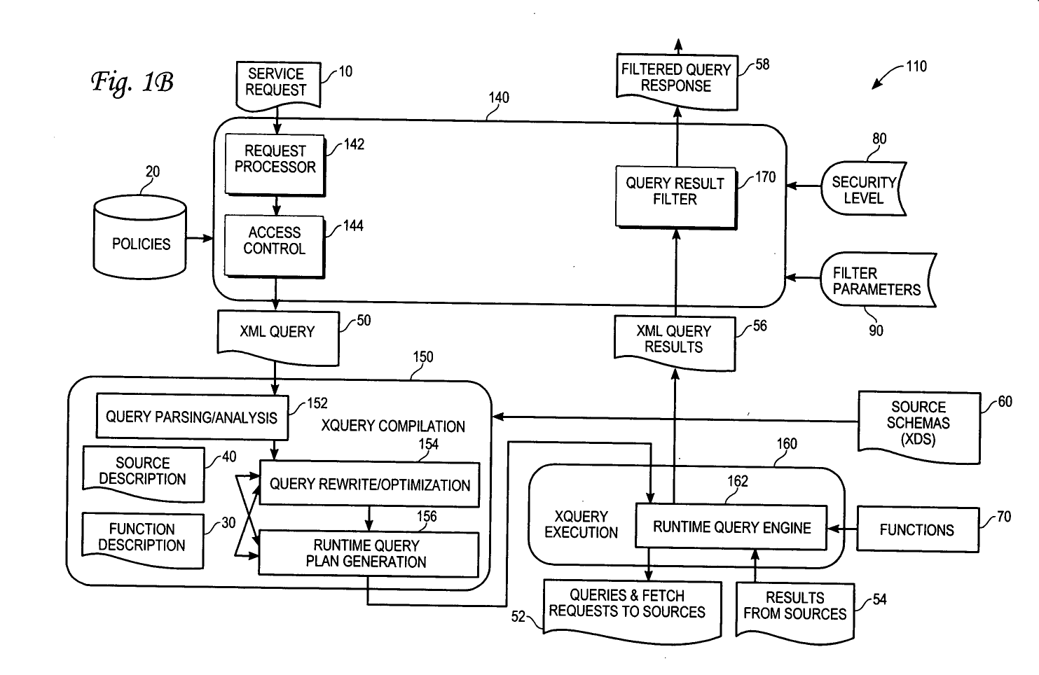

FIGS. 1A-1B are functional block diagrams illustrating an example computing environment in which techniques for data redaction may be implemented in one embodiment. As shown in FIG. 1A, a liquid data framework 104 is used to provide a mechanism by which a set of applications, or application portals 94, 96, 98, 100 and 102, can integrate with, or otherwise access in a tightly couple manner, a plurality of services. Such services may include a Materials Requirements and Planning (MRP) system 112, a purchasing system 114, a third-party relational database system 116, a sales forecast system 118 and a variety of other data-related services 120. Although not shown in FIG. 1A for clarity, in one embodiment, one or more of the services may interact with one or more other services through the liquid data framework 104 as well.

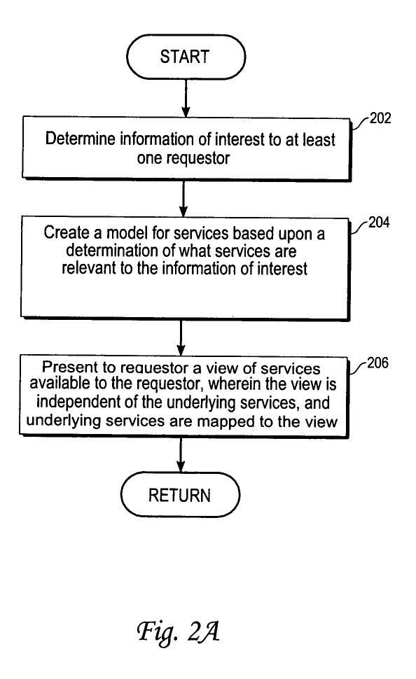

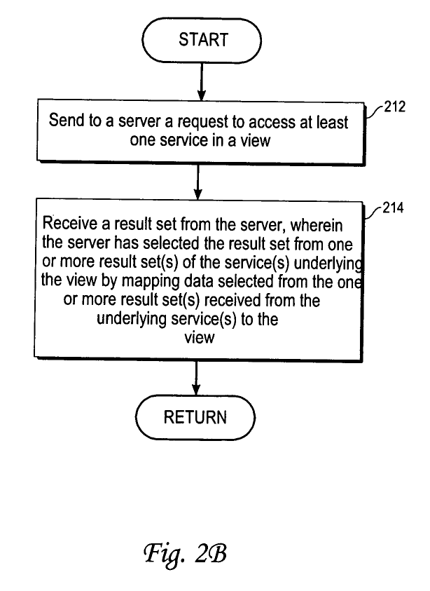

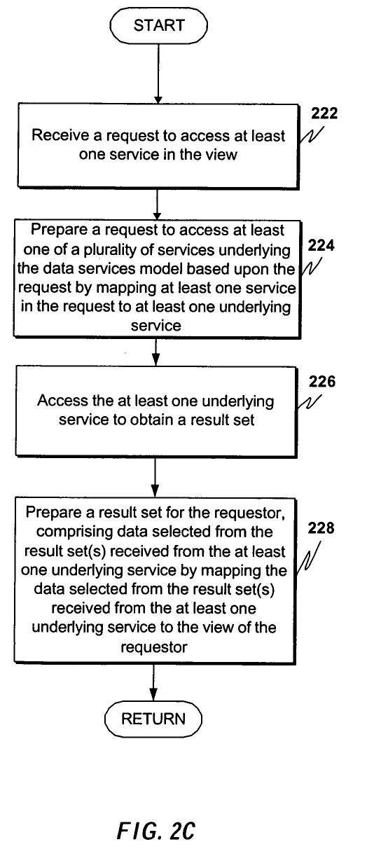

Internally, the liquid data framework 104 employs a liquid data integration engine 110 to process requests from the set of portals to the services. The liquid data integration engine 110 allows access to a wide variety of services, including data storage services, server-based or peer-based applications, Web services and other services capable of being delivered by one or more computational devices are contemplated in various embodiments. A services model 108 provides a structured view of the available services to the application portals 94, 96, 98, 100 and 102. In one embodiment, the services model 108 provides a plurality of views 106 that may be filtered, molded, or shaped views of data and/or services into a format specifically suited for each portal application 94, 96, 98, 100 and 102. In one embodiment, data returned by services to a particular application (or other service acting as a requestor or client) is mapped to the view 106 associated with that application (or service) by liquid data framework 104. Embodiments providing multiple views of available services can enable organizations to compartmentalize or streamline access to services, thereby increasing the security of the organization's IT infrastructure. In one embodiment, services model 108 may be stored in a repository 122 of service models. Embodiments providing multiple services models can enable organizations to increase the flexibility in changing or adapting the organization's IT infrastructure by lessening dependence on service implementations. Techniques for modeling data services implemented by liquid data framework 104 will be described below in greater detail with reference to FIGS. 2A-2C.

FIG. 1B is a high level schematic of a liquid data integration engine 110 illustrated in FIG. 1A with reference to one example embodiment. As shown in FIG. 1B, the liquid data integration engine 110 includes an interface processing layer 140, a query compilation layer 150 and a query execution layer 160. The interface layer 140 includes a request processor 142, which takes the request 10 and processes this request into an XML query 50. Interface layer 140 also includes access control mechanism 144, which determines based upon a plurality of policies 20 whether the client, portal application, service or other process making the request 10 is authorized to access the resources and services required to satisfy the request. Provided that the client, application, service or other process is authorized to make the request 10, the interface layer sends the XML query 50 to the query compilation layer 150.

Within the query compilation layer 150, a query parsing and analysis mechanism 152 receives the query 50 from the client applications, parses the query and sends the results of the parsing to a query rewrite optimizer 154. The query rewrite optimizer 154 determines whether the query can be rewritten in order to improve performance of servicing the query based upon one or more of execution time, resource use, efficiency or other performance criteria. The query rewrite optimizer 154 may rewrite or reformat the query based upon input from one or more of a source description 40 and a function description 30 if it is determined that performance may be enhanced by doing so. A runtime query plan generator 156 generates a query plan for the query provided by the query rewrite optimizer 154 based upon input from one or more of the source description 40 and the function description 30.

The query compilation layer 150 passes the query plan output from the runtime query plan generator 156 to a runtime query engine 162 in the query execution layer 160. The runtime query engine 162 is coupled with one or more functions 70 that may be used in conjunction with formulating queries and fetch requests to sources 52, which are passed on to the appropriate service(s). The service responds to the queries and fetch requests 52 with results from sources 54. The runtime query engine 162 of the query execution layer 160 translates the results into a format usable by the client or portal application, such as without limitation XML, in order to form the XML query results 56.

Before responses or results 56 are passed back to the client or portal application making the request, a query result filter 146 in the interface layer 140 determines based upon filter parameters 90 what portion of the results will be passed back to the client or portal application, forming a filtered query response 58. Although not shown in FIG. 1B for clarity, filter parameters 90 may accompany service request 10 in one embodiment. Further, query result filter 146 also determines based upon access policies implementing security levels 80 what portions of the filtered query response 58 a requestor is permitted to access and may redact the filtered query response accordingly. Although not shown in FIG. 1B for clarity, access policies implementing security levels 80 may be stored with policies 20 in one embodiment. When properly formed, the response is returned to the calling client or portal application.

FIG. 2A is an operational flow diagram illustrating a high level overview of a technique for modeling data services of one embodiment of the present invention. The technique for modeling data services shown in FIG. 2A is operable with an application sending data, such as Materials Requirements and Planning (MRP) system 112, an purchasing system 114, a third-party relational database system 116, sales forecast system 118, or a variety of other data-related services 120 of FIG. 1A, for example. As shown in FIG. 2A, information of interest to at least one requestor are determined (block 202). A data model for data services is created based upon a determination of which data services are relevant to the information of interest (block 204). A view of data services available to the requestor is presented to the requestor (block 206). The view of data services is substantially independent of structure or format of the data services underlying the model, and wherein data services underlying the model are mapped to the view. In one embodiment, the method illustrated by blocks 202-206 may be advantageously disposed in the interface processing layer 140, query compilation layer 150 and query execution layer 160 of FIG. 1B.

FIG. 2B is an operational flow diagram illustrating a high level overview of a client process operable with the technique for accessing a service illustrated in FIG. 2A. The technique for exchanging data with data services using a data model shown in FIG. 2B is operable with an application sending or receiving data, such as applications 94, 96, 98, 100 and 102 of FIG. 1A, for example or a service, such as Materials Requirements and Planning (MRP) system 112, an purchasing system 114, a third-party relational database system 116, sales forecast system 118, or a variety of other data-related services 120 of FIG. 1A. As shown in FIG. 2B, sending a request to access at least one service in a view; receiving a result set, the result set comprising data selected from at least one of a plurality of result set(s) received from at least one of a plurality of services underlying the view by mapping the data selected from the result set(s) received from the at least one underlying service(s) to the at least one service indicated in the request.

FIG. 2C is an operational flow diagram of an example a technique for servicing a request to access a service, which may be used in conjunction with the technique illustrated in FIG. 2A. As shown in FIG. 2C, a request to access at least one service in the view is received (block 222). A request to access at least one of a plurality of services underlying the data services model based upon the request is prepared (block 224). The request is prepared by mapping at least one service in the request to at least one underlying service. The at least one underlying service is accessed to obtain a result set (block 226). A result set is prepared for the requestor (block 228). The result set for the requestor comprises data selected from the result set(s) received from the at least one underlying service by mapping the data selected from the result set(s) received from the at least one underlying service to the at least one service indicated by the request.

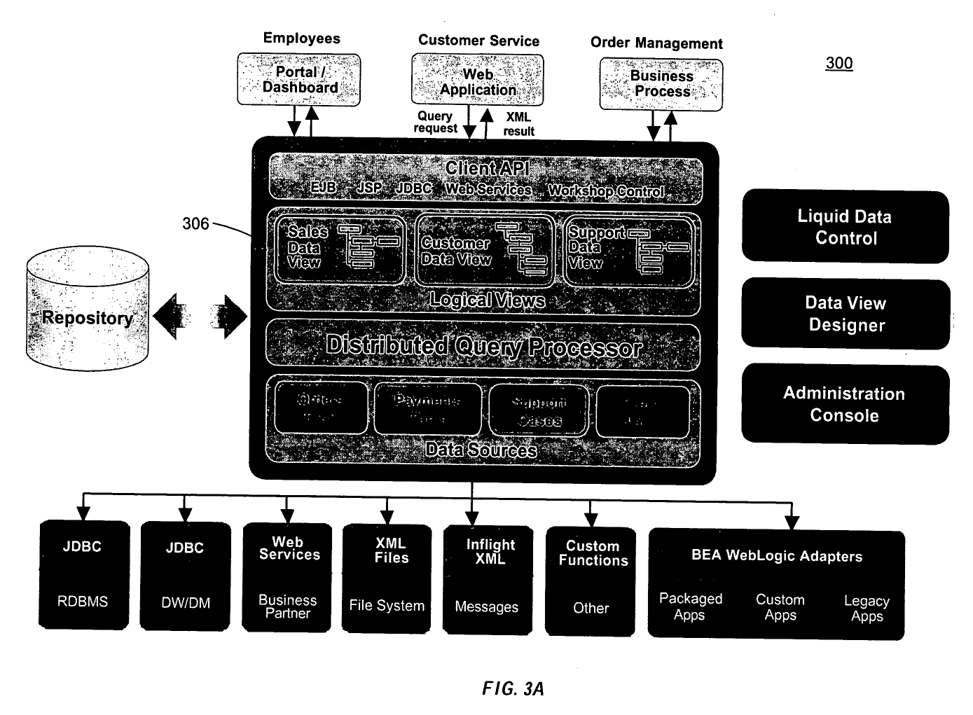

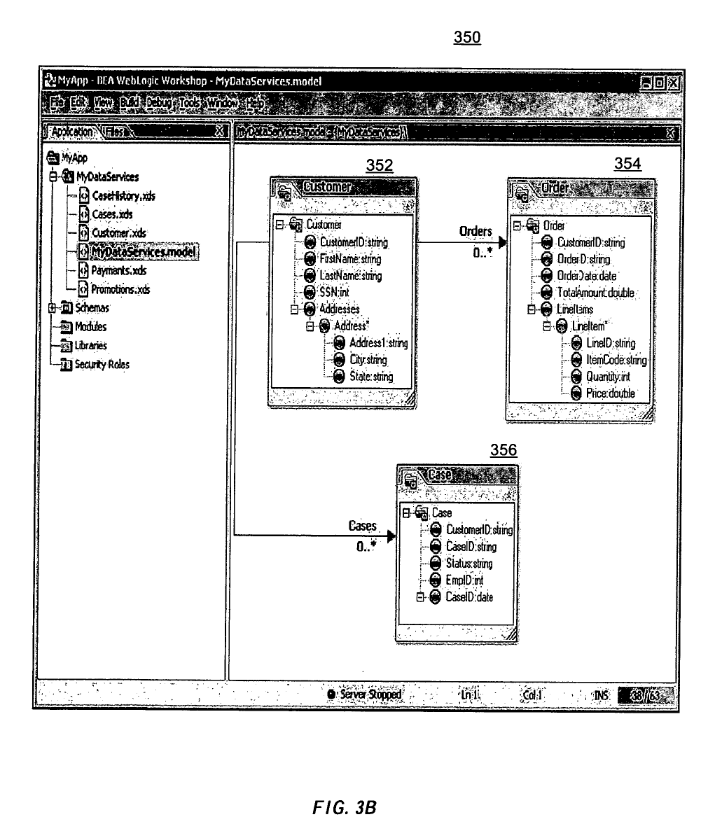

Some of the features and benefits of the present invention will be illustrated with reference to FIG. 3A, which is a screen shot illustrating a high level overview of an example view according to an example services model operable with the technique for modeling services illustrated in FIGS. 2A-2C. As shown in FIG. 3A, a view 306 created for one or more data services may be used to display a presentation of data services available to a requestor interested in sales data related services. Additionally, FIG. 3A illustrates a customer data services view and a support data view. Other views, not shown in FIG. 3A for clarity, may also be included by some embodiments.

Now with reference to FIG. 3B, a screen shot of an example modeling tool embodiment is illustrated. As shown in FIG. 3B, a modeling tool presentation 350 displays a plurality of information entities, such as a customer information entity 352, an order information entity 354 and a case information entity 356. Using the presentation 350, an IT administrator, for example, can create business entities, capture relationships between entities and define mapping of logical entities to physical data sources and/or services. Model creation tools, such as that illustrated by FIG. 3B, can provide in various embodiments, XML Metadata Interchange (XMI) based interchange with Unified Modeling Language (UML) tools, an easier way to organize and present data services to developers, a way to more rapidly create logical data model(s) that span across multiple data sources and/or services.

In embodiments directed to enterprise class projects, a data services model is created to logically organize the data services. The data services model comprises a critical link in the organization of a large quantity of data services in the typical enterprise. Without a data model, enterprises have only a list of potentially thousands of services, but no indication what service is accessible to whom or where the service resides. One benefit of the Liquid Data framework is that users are enabled to create a data model to organize data services. Using the Liquid Data framework, users can define entities (like Customer, Order) in the information and define services relevant to the entities (like getcustomerbyID). The data model can span multiple underlying sources of services. These multiple underlying sources can be integrated into a unified data model by the Liquid Data framework. In addition to organizing the services, the unified data model also enables users to define business rules for the data elements. The unified data model presents a single, unified view of underlying data services, regardless of the source, structure or format of the underlying data services. In this way, a data model becomes an effective way to solve the complexity of data discovery and aggregation.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Included in the programming (software) of the general/specialized computer or microprocessor are software modules for implementing the teachings of the present invention, including, but not limited to providing mechanisms and methods for modeling data services as discussed herein.

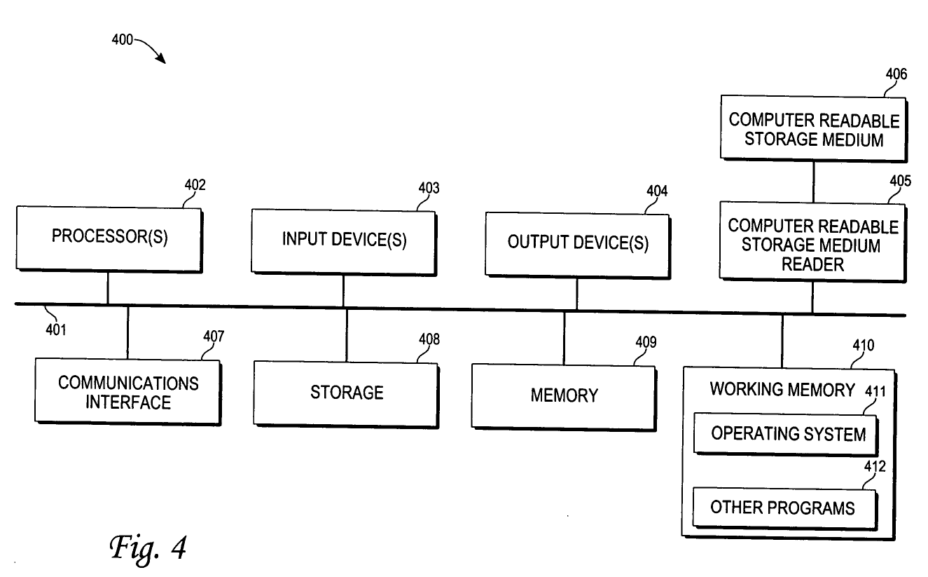

FIG. 4 illustrates an exemplary processing system 400, which can comprise one or more of the elements of FIGS. 1A and 1B. Turning now to FIG. 4, an exemplary computing system is illustrated that may comprise one or more of the components of FIGS. 1A and 1B. While other alternatives might be utilized, it will be presumed for clarity sake that components of the systems of FIGS. 1A and 1B are implemented in hardware, software or some combination by one or more computing systems consistent therewith, unless otherwise indicated.

Computing system 400 comprises components coupled via one or more communication channels (e.g., bus 401) including one or more general or special purpose processors 402, such as a Pentium®, Centrino®, Power PC®, digital signal processor (“DSP”), and so on. System 400 components also include one or more input devices 403 (such as a mouse, keyboard, microphone, pen, and so on), and one or more output devices 404, such as a suitable display, speakers, actuators, and so on, in accordance with a particular application. (It will be appreciated that input or output devices can also similarly include more specialized devices or hardware/software device enhancements suitable for use by the mentally or physically challenged.)

System 400 also includes a computer readable storage media reader 405 coupled to a computer readable storage medium 406, such as a storage/memory device or hard or removable storage/memory media; such devices or media are further indicated separately as storage 408 and memory 409, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 407 may also be included, such as a modem, DSL, infrared, RF or other suitable transceiver, and so on for providing inter-device communication directly or via one or more suitable private or public networks or other components that may include but are not limited to those already discussed.

Working memory 410 further includes operating system (“OS”) 411 elements and other programs 412, such as one or more of application programs, mobile code, data, and so on for implementing system 400 components that might be stored or loaded therein during use. The particular OS or OSs may vary in accordance with a particular device, features or other aspects in accordance with a particular application (e.g. Windows, WindowsCE, Mac, Linux, Unix or Palm OS variants, a cell phone OS, a proprietary OS, Symbian, and so on). Various programming languages or other tools can also be utilized, such as those compatible with C variants (e.g., C++, C#), the Java 2 Platform, Enterprise Edition (“J2EE”) or other programming languages in accordance with the requirements of a particular application. Other programs 412 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 408 or memory 409) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for modeling data services, the method comprising:
determining information of interest to at least one requestor;
creating a model for the data services based upon determination of which data services are relevant to information of interest; and
presenting to a requestor a view of data services available to the requestor, wherein the view of data services is independent of structure and/or format of the data services underlying the model, and wherein data services underlying the model are mapped to the view.

2. The method of claim 1, further comprising:
receiving, from the requestor, a request to access at least one service in the view;
preparing a request to access at least one of a plurality of services underlying the data services model based upon the request by mapping the at least one service in the request to the at least one underlying service;
accessing the at least one underlying service to obtain a result set; and
preparing a result set for the requester, comprising data selected from the result set(s) received from the at least one underlying service by mapping the selected data from the result set(s) received from the at least one underlying service to the view associated with the requestor.

3. The method of claim 1, wherein creating a data model for data services comprises:
defining entities in the information of interest; and
defining services relevant to the entities.

4. The method of claim 1, wherein presenting a view of data services available to the requestor comprises:
integrating multiple underlying services into a unified data services model.

5. The method of claim 1, wherein presenting a view of data services available to the requestor comprises:
organizing multiple services into a unified data services model.

6. The method of claim 1, further comprising:
creating a second model for the data services, the second model enabling a second view of the data services to the requester.

7. The method of claim 1, wherein a view of data services comprises:
a mechanism that provides a presentation of data and/or services in a format suited for a particular application, service, client or process.

8. The method of claim 1, wherein a data service comprises:
a mechanism resident on one or more computing devices capable of providing services to a requestor or other recipient.

9. The method of claim 1, wherein a model comprises:
a construct for representing a plurality of entities in information and at least one relationship between the entities.

10. A method for exchanging data with data services using a data model, the method comprising:
sending a request to access at least one service in a view;
receiving a result set, the result set comprising data selected from at least one of a plurality of result set(s) received from at least one of a plurality of services underlying the view by mapping the data selected from the result set(s) received from the at least one underlying service(s) to the view.

11. A computer-readable medium carrying one or more sequences of instructions for modeling data services, which instructions, when executed by one or more processors, cause the one or more processors to carry out the steps of:
determining information of interest to at least one requestor;
creating a model for the data services based upon determination of which data services are relevant to information of interest; and
presenting to a requestor a view of data services available to the requester, wherein the view of data services is independent of structure and/or format of the data services underlying the model, and wherein data services underlying the model are mapped to the view.

12. The computer-readable medium as recited in claim 11, further comprising instructions for carrying out the steps of:
receiving, from the requester, a request to access at least one service in the view;
preparing a request to access at least one of a plurality of services underlying the data services model based upon the request by mapping the at least one service in the request to the at least one underlying service;
accessing the at least one underlying service to obtain a result set; and
preparing a result set for the requester, comprising data selected from the result set(s) received from the at least one underlying service by mapping the selected data from the result set(s) received from the at least one underlying service to the view associated with the requestor.

13. The computer-readable medium as recited in claim 11, wherein the instructions for carrying out the step of creating a data model for data services further comprise instructions for carrying out the steps of:
defining entities in the information of interest; and
defining services relevant to the entities.

14. The computer-readable medium as recited in claim 11, wherein the instructions for carrying out the step of presenting a view of data services available to the requestor further comprise instructions for carrying out the steps of:
integrating multiple underlying service sources into a unified data services model.

15. The computer-readable medium as recited in claim 11, wherein the instructions for carrying out the step of presenting a view of data services available to the requestor further comprise instructions for carrying out the steps of:
organizing multiple services into a unified data services model.

16. The computer-readable medium as recited in claim 11, further comprising instructions for carrying out the steps of:
creating a second model for the data services, the second model enabling a second view of the data services to the requestor.

17. The computer-readable medium as recited in claim 11, wherein a view of data services comprises:
a mechanism that provides a presentation of data and/or services in a format suited for a particular application, service, client or process.

18. The computer-readable medium as recited in claim 11, wherein a data service comprises:
a mechanism resident on one or more computing devices capable of providing services to a requestor or other recipient.

19. The computer-readable medium as recited in claim 11, wherein a model comprises:
a construct for representing a plurality of entities in information and at least one relationship between the entities.

20. An apparatus for modeling data services, the apparatus comprising:
a processor; and
one or more stored sequences of instructions which, when executed by the processor, cause the processor to carry out the steps of:
determining information of interest to at least one requestor;
creating a model for the data services based upon determination of which data services are relevant to information of interest; and
presenting to a requestor a view of data services available to the requestor, wherein the view of data services is independent of structure and/or format of the data services underlying the model, and wherein data services underlying the model are mapped to the view.
